(19) United States
(12) Patent Application Publication
(10) Pub. No.: US 2026/0332947 A1
(43) Pub. Date: Oct. 22, 2026

(54) TILTED SLOT WAVEGUIDE

(71) Applicant: Dolby Laboratories Licensing Corporation, San Francisco, CA (US)

(72) Inventors: Kelvin Francis GRIFFITHS, Porthcawl (GB); Michael J. SMITHERS, Kareela (AU)

(73) Assignee: Dolby Laboratories Licensing Corporation, San Francisco, CA (US)

(21) Appl. No.: 19/108,638

(22) PCT Filed: Aug. 24, 2023
(86) PCT No.: PCT/US2023/072806

§ 371 Date: Mar. 4, 2025

Related U.S. Application Data
(60) Provisional application No. 63/404,590, filed on Sep. 8, 2022.

(30) Foreign Application Priority Data
Dec. 19, 2022 (EP) 22214532.8

(51) Int. Cl. H04R 1/34; B60R 11/00; B60R 11/02; H04R 1/02

(52) U.S. Cl. CPC H04R 1/345; B60R 11/0217; H04R 1/025; B60R 2011/0022; H04R 2499/13

(57) ABSTRACT

A loudspeaker assembly including a wedge-shaped acoustic waveguide and an audio driver. The wedge-shaped acoustic waveguide includes a first face including a slot opening formed therein, a second face joined at an edge with the first face, the second face tilted relative to the first face by a first angle, and a surface disposed opposite the edge and connected between the first face and the second face. The audio driver is coupled to the second face such that the audio driver is tilted at the first angle relative to the first face. The first face is oriented to face in a first direction and the audio driver is oriented to face in a second direction. A pressure level of sound energy emitted by the audio driver is greater along the second direction than the first direction. A vehicle comprising: a passenger cabin, a pillar extending upwards at a first angle relative to the passenger cabin, and the loudspeaker assembly installed on the pillar.

### CROSS-REFERENCE TO RELATED APPLICATIONS

This application claims the benefit of priority from U.S. Provisional Application No. 63/404,590, filed on 8 Sep. 2022 and European Patent Application No. 22214532.8 filed on 19 Dec. 2022, each of which is incorporated by reference herein in its entirety.

### BACKGROUND

### 1. Field of the Disclosure

This application relates generally to acoustic waveguides for loudspeakers used in vehicles.

### BRIEF SUMMARY OF THE DISCLOSURE

The dispersion of sound energy throughout a vehicle is often directed to and/or concentrated at lower heights within the passenger cabin, such as near the feet of passengers riding in the vehicle. In some instances, this may be attributed to the sound stage within a passenger cabin often being disposed at a lower height relative to the head of a passenger, as the loudspeakers included in vehicles are often positioned within the bottoms of vehicle doors and/or other locations below the height of the vehicle dashboard. In some instances, the sound stage within a passenger cabin is disposed at a lower height relative to the head of a passenger because one or more loudspeakers disposed within the vehicle cabin are oriented to face in a direction that is below the head of a passenger (e.g., tilted to face downward). When sound dispersion is directed to and/or concentrated at lower elevations within the passenger cabin, the quality of the listening experience for vehicle passengers is reduced. Thus, a loudspeaker that emits sound energy having a high horizontal dispersion and a controlled vertical dispersion at the listening position of a passenger is desired.

Furthermore, the audio system in which a loudspeaker is included may be a multi-channel audio system that includes height channels associated with audio that is intended to be reproduced above the listening position of a passenger. Thus, in such instances, it is further desired for the loudspeaker to emit, or reproduce, sound energy associated with the height channels at an elevation above the listening position of the passenger.

Various aspects of the present disclosure relate to acoustic waveguides and methods for designing acoustic waveguides for use with loudspeakers included in a vehicle. For example, in some aspects, the disclosure provides an acoustic waveguide that is used for controlling the directivity of sound energy emitted by a vehicle loudspeaker. In such aspects, the acoustic waveguide may have a wedge-shaped body that tilts the audio driver of the loudspeaker to face in a direction towards the vehicle passengers. In effect, tilting the audio driver towards the vehicle passengers results in a higher concentration of emitted sound energy at the listening position of the passengers.

In one example aspect of the present disclosure, there is provided a loudspeaker assembly including a wedge-shaped acoustic waveguide and an audio driver. The wedge-shaped acoustic waveguide includes a first face including a slot opening formed therein, a second face joined at an edge with the first face, the second face tilted relative to the first face by a first angle, and a surface disposed opposite the edge and connected between the first face and the second face. The audio driver is coupled to the second face such that the audio driver is tilted at the first angle relative to the first face.

In another example aspect of the present disclosure, there is provided an acoustic waveguide for use with an audio driver. The acoustic waveguide includes a wedge-shaped body, a first face including a slot opening formed therein, a second face joined at an edge with the first face, the second face tilted relative to the first face by a first angle, and a surface disposed opposite the edge and connected between the first face and the second face.

In another example aspect of the present disclosure, there is provided a vehicle including a passenger cabin, a pillar extending upwards at a first angle relative to the passenger cabin, and a loudspeaker assembly installed on the pillar. The loudspeaker assembly includes a wedge-shaped acoustic waveguide including a first face including a slot opening formed therein, a second face joined at an edge with the first face, the second face tilted relative to the first face by a second angle, and a surface disposed opposite the edge and connected between the first face and the second face. The loudspeaker assembly further includes an audio driver coupled to the second face such that the audio driver is tilted at the second angle relative to the first face.

### DESCRIPTION OF THE DRAWINGS

These and other more detailed and specific features of various instances are more fully disclosed in the following description, reference being had to the accompanying drawings, in which:

FIG. 1 illustrates an example vehicle according to various aspects of the present disclosure;

FIG. 2 illustrates a first example perspective view of a vehicle passenger cabin in which a loudspeaker assembly is installed according to various aspects of the present disclosure;

FIG. 3 illustrates a second example perspective view of a vehicle passenger cabin in which a loudspeaker assembly is installed according to various aspects of the present disclosure;

FIG. 4 illustrates an example side view of a vehicle passenger cabin in which a loudspeaker assembly is installed according to various aspects of the present disclosure;

FIG. 5 illustrates a frontal view of an acoustic waveguide included in a loudspeaker assembly according to various aspects of the present disclosure;

FIG. 6 illustrates an example side view of a vehicle passenger cabin in which a loudspeaker assembly is installed according to various aspects of the present disclosure;

FIGS. 7A-7C illustrate various example perspective views of an acoustic waveguide according to various aspects of the present disclosure;

FIG. 8 illustrates an example perspective view of an audio driver coupled to an interface of an acoustic waveguide according to various aspects of the present disclosure;

FIGS. 9A and 9B illustrate example perspective views of an acoustic waveguide according to various aspects of the present disclosure;

FIG. 10 illustrates an example dispersion of sound energy emitted by a loudspeaker assembly according to various aspects of the present disclosure;

FIG. 11 is a diagram illustrating geometric constraints used for designing an acoustic waveguide according to various aspects of the present disclosure;

FIGS. 12A-12D illustrate example effects of adjusting a tilt angle of a straight acoustic waveguide on sound energy dispersion according to various aspects of the present disclosure;

FIG. 13A-13D illustrate example effects of adjusting a tilt angle of an arc-shaped acoustic waveguide on sound energy dispersion according to various aspects of the present disclosure;

FIGS. 14A-14D illustrate example contours of sound energy emitted by loudspeaker assemblies including an acoustic waveguide according to various aspects of the present disclosure;

FIGS. 15A-15D are polar charts that illustrate the effects of tilting an audio driver on sound energy dispersion according to various aspects of the present disclosure; and

FIGS. 16A-16D illustrate example effects of adjusting the width of a slot opening of an acoustic waveguide on sound energy dispersion according to various aspects of the present disclosure.

### DETAILED DESCRIPTION

In the following description, numerous details are set forth, such as details regarding acoustic waveguides and/or loudspeaker assemblies implemented in vehicles, in order to provide an understanding of one or more aspects of the present disclosure. It will be readily apparent to one skilled in the art that these specific details are merely examples and not intended to limit the scope of this application.

Moreover, while the present disclosure focuses mainly on examples in which the acoustic waveguides and associated loudspeaker assemblies described herein are implemented in a vehicle, it should be understood that the acoustic waveguides described herein may be used with loudspeaker assemblies implemented in other applications in which a high horizontal dispersion of audio and/or a controlled vertical dispersion of audio is desired. For example, in some instances, the acoustic waveguides described herein may be used with loudspeaker assemblies implemented in multi-channel audio systems used for applications such as television, home theaters, cinemas, concert venues, and the like. In such instances, the acoustic waveguides and associated loudspeaker assemblies described herein present audio associated with height channels at positions elevated above the listening position (e.g., above head height). For example, the acoustic waveguides and associated loudspeaker assemblies herein may be arranged to direct emitted sound energy associated with the height channels to be concentrated at a location above the heads of viewers of a television, in a home theater, a cinema, a concert venue, and the like.

As described above, the dispersion of sound energy emitted by loudspeakers included in a vehicle is often directed to and/or concentrated at lower heights within the passenger cabin. In some instances, this may be attributed to the sound stage within a passenger cabin often being disposed at a lower height relative to the listening position of the passenger. For example, vehicle audio systems often include loudspeakers that are disposed below the listening position of a passenger (e.g., within the bottoms of vehicle doors, in or below the vehicle dashboard, and/or at other locations below the listening position of a passenger) and/or loudspeakers that are oriented to face in a direction below the listening position of a passenger.

Accordingly, it would be advantageous to raise the sound stage within a passenger cabin by leveraging elevated structures of the vehicle, such as the vehicle pillars, for mounting the loudspeakers at positions near and/or above the listening position of the passenger. Vehicle pillars are components that support the structure of an enclosed automobile body. For example, vehicle pillars are designed to stand in near vertical or inclined positions to support the roof, windshield, rear window, and other components of the vehicle. Since the vehicle pillars are used to support the vehicle roof, the vehicle pillars extend to high elevations within the passenger cabin.

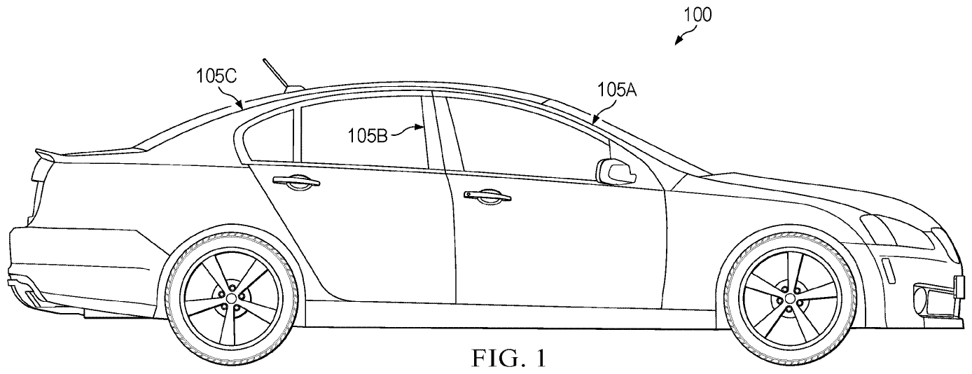

FIG. 1 illustrates an example of a common passenger vehicle 100, such as a sedan, that includes A-pillars 105A, B-pillars 105B, and C-pillars 105C. The A-pillars 105A are disposed on each side of the vehicle's windshield and extend upward to support the front end of the vehicle's roof. As shown, the A-pillars 105A extend upward at an angle, or incline, in the direction of the vehicle passengers. The B-pillars 105B, which are sometimes referred to as posts, extend upward to support the middle portion of the vehicle's roof and the C-pillars 105C extend upward at an incline to support the rear end of the vehicle's roof. As will be described in more detail below, loudspeakers and acoustic waveguides described herein may be installed on one or more of the vehicle pillars 105A, 105B, and 105C to improve the horizontal and vertical dispersion of sound energy throughout the vehicle 100. Installing a loudspeaker and associated waveguide on a vehicle pillar may include mounting the loudspeaker and/or associated waveguide to and/or within a vehicle pillar.

It should be understood that vehicle 100 shown in FIG. 1 and described herein is provided merely as an example and is not intended to limit implementation of the loudspeakers and/or acoustic waveguides described herein in any way. For example, the loudspeakers and/or acoustic waveguides described herein may also be implemented in vehicles that have more than three sets of pillars, such as sport utility vehicles that include four sets of pillars or passenger vans that include five sets of pillars. In another example, the loudspeakers and/or acoustic waveguides described herein may be implemented in vehicles that have less than three sets of pillars, such as coupes that only have two sets of pillars. Hereinafter, the loudspeakers and/or acoustic waveguides described herein may be referred to collectively as “loudspeaker assemblies” throughout the disclosure.

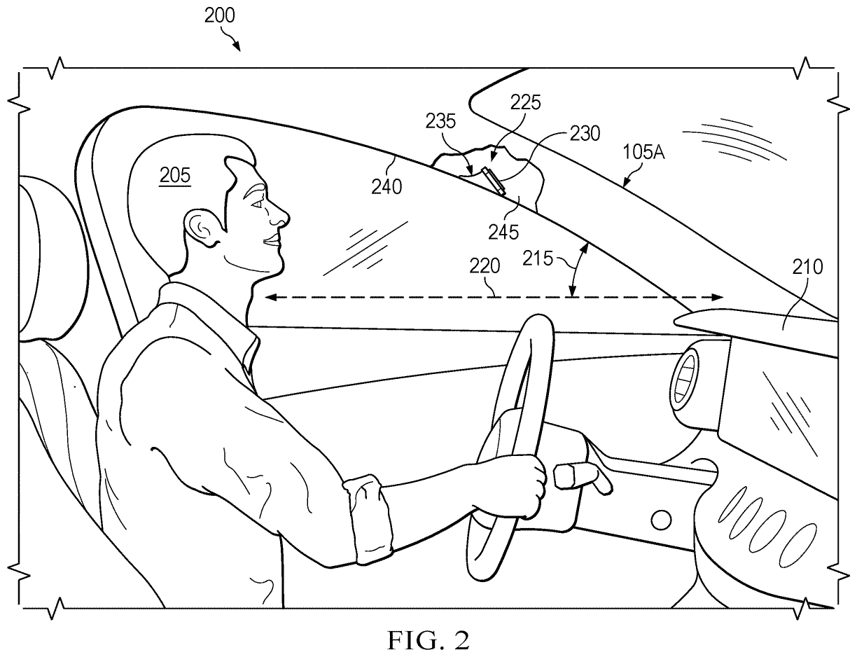

FIG. 2 illustrates a first perspective view of the interior passenger cabin 200 of the vehicle 100. As shown, a passenger 205 facing in the general direction of the A-pillar 105A (e.g., towards the windshield) is seated in the passenger cabin 200. The A-pillar 105 extends upward from the dashboard 210 at a first angle 215 relative to a horizontal axis 220 that extends from the dashboard 210 towards the passenger 205. That is, the A-pillar 105A is inclined at the first angle 215 relative to the passenger 205. As will be described in more detail below, a loudspeaker assembly 225 is installed on the A-pillar 105 at a height that is elevated near and/or above the height of the listening position of passenger 205. The loudspeaker assembly 225 includes, among other things, a loudspeaker driver, such as an electrodynamic transducer, 230 and an acoustic waveguide 235 coupled to the driver 230. Hereinafter, the loudspeaker driver 230 may simply be referred to as the “driver 230” and the acoustic waveguide 235 may simply be referred to as the “waveguide 235.”

Largely for aesthetic purposes, industrial designers prefer that accessory devices, such as speakers, displays, etc., included in a vehicle do not interfere with the interior design of the passenger cabin 200. Thus, it is desirable to install a loudspeaker assembly 225 on the A-pillar 105A, as well as any other pillar (e.g., B-pillar 105B, C-pillar 105C, etc.) to which a loudspeaker assembly 225 might be mounted, while having minimal impact on the interior aesthetic of the passenger cabin 200. Accordingly, as shown in FIG. 2, the loudspeaker assembly 225 is installed on the A-pillar 105A such that the loudspeaker assembly 225 is disposed between the A-pillar 105A and an interior trim panel 240 that covers the A-pillar 105A. For example, the interior trim panel 240 may be coupled to the A-pillar 105A in a manner such that an interior space 245 accommodating the loudspeaker assembly 225 is defined between the trim panel 240 and the A-pillar 105A. In some instances, the loudspeaker assembly 225 is mounted to an inner surface of the A-pillar 105A. That is, in some instances, the loudspeaker assembly 225 includes one or more components that are mounted or otherwise coupled to the surface of the A-pillar 105A that faces in the direction of the passenger cabin 200. In some instances, the loudspeaker assembly 225 is mounted to the trim panel 240. In other instances, the loudspeaker assembly 225 is mounted to both the A-pillar 105A and the trim panel 240.

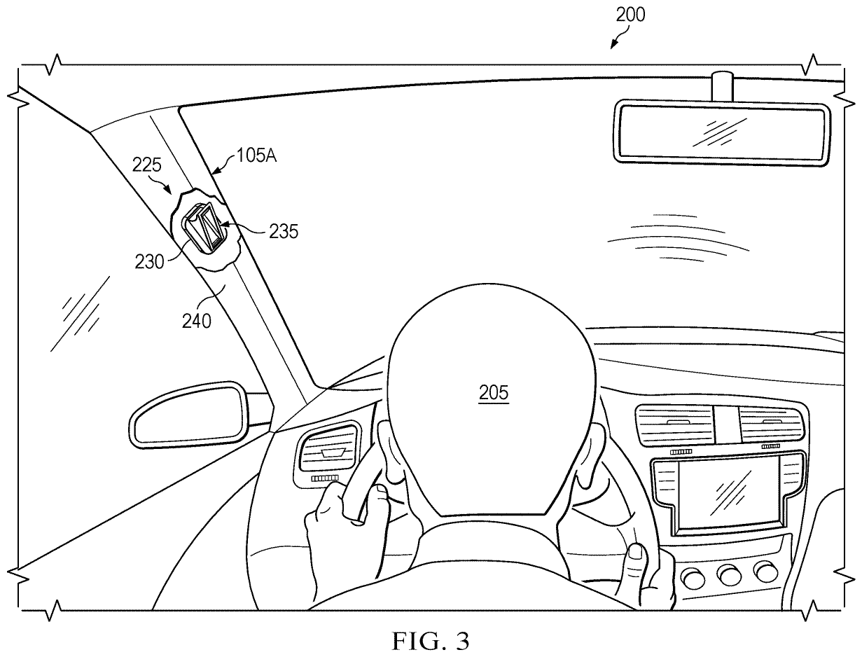

In some instances, the loudspeaker assembly 225 is installed on the A-pillar 105 such that a front face of the waveguide 235 is flush with the surface of the trim panel 240. For example, FIG. 3 illustrates a second perspective view of the passenger cabin 200 in which the front face of the waveguide 235 is flush with the trim panel 240. As shown, the front face of the waveguide 235 is exposed through an opening, or cutout, formed in the trim panel 240. Accordingly, in this example, the loudspeaker assembly 225 can be installed on the A-pillar 105A at a high elevation in the passenger cabin 200 without sacrificing the interior aesthetic of the passenger cabin 200. It should be understood that although the loudspeaker assembly 225 is illustrated and described as being installed on the A-pillar 105A in the examples of FIGS. 2 and 3, the loudspeaker assembly 225 can similarly be installed on other pillars, such as the B-pillars 105B and/or the C-pillars 105C, in the vehicle 100.

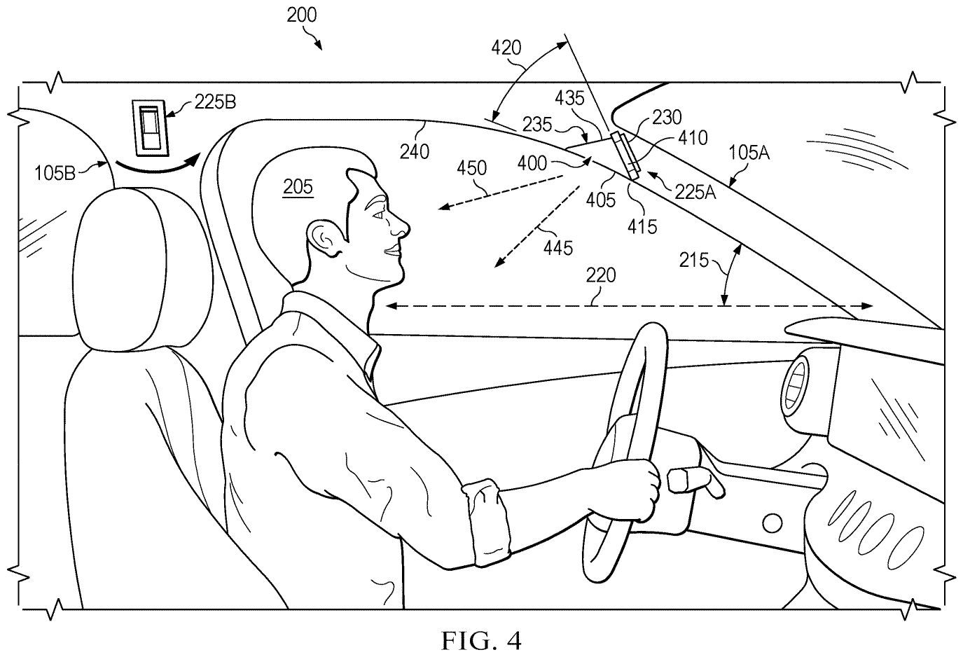

FIG. 4 illustrates an example side view of the passenger cabin 200 according to some aspects of the present disclosure. It should be understood that some of the components illustrated in FIG. 4 are not drawn to scale. For example, some components included in the loudspeaker assembly 225 are enlarged in scale relative to other features of the vehicle 100 such that particular features of the loudspeaker assembly 225 can be clearly shown.

As shown in FIG. 4, a loudspeaker assembly 225A is disposed within the interior space between the A-pillar 105A and the trim panel 240. For example, the loudspeaker assembly 225A is mounted to the A-pillar 105A and/or the trim panel 240 as described above. In the illustrated example, the loudspeaker assembly 225A is mounted at an elevation within the passenger cabin 200 that is at and/or higher than the elevation of the passenger's 205 listening position. As further shown in FIG. 4, a second loudspeaker assembly 225B is mounted to the B-pillar 105B. Although the illustrated example of FIG. 4 will primarily be described with respect to the loudspeaker assembly 225A installed on the A-pillar 105A, it should be understood that any description provided with respect to the loudspeaker assembly 225A is also applicable to the second loudspeaker assembly 225B installed on the B-pillar 105B.

As described above with respect to FIGS. 2 and 3, the loudspeaker assembly 225A includes a driver 230 and a waveguide 235. In some instances, the driver 230 is implemented as a high aspect ratio driver. In such instances, the aspect ratio of the driver 230 may be 1:2 or greater. In some instances, the driver 230 is implemented as a rectangular driver. In other instances, the driver 230 is of a different shape, such as a conical driver, an ellipse-shaped driver, a round driver, or some other shape of driver. The driver 230 may be implemented as, for example, a tweeter, a mid-range driver, a woofer, or a combination of one or more thereof. In some instances, the driver 230 emits sound waves at frequencies of up to 20 kilohertz (kHz). In other instances, sound waves are emitted by the driver 230 at different and/or additional frequencies. As will be described in more detail below, the waveguide 235 is coupled with the driver 230 to direct sound energy emitted by the driver 230 in a direction towards the listening position of the passenger 205.

In some instances, the audio system in the vehicle 100 is a multi-channel audio system and the loudspeakers assembly 225A is used to reproduce audio associated with one or more height channels included in the multi-channel audio system. In such instances, the waveguide 235 is coupled with the driver 230 such that sound energy emitted by the driver 230 is presented, or reproduced, above the listening position of the passenger 205.

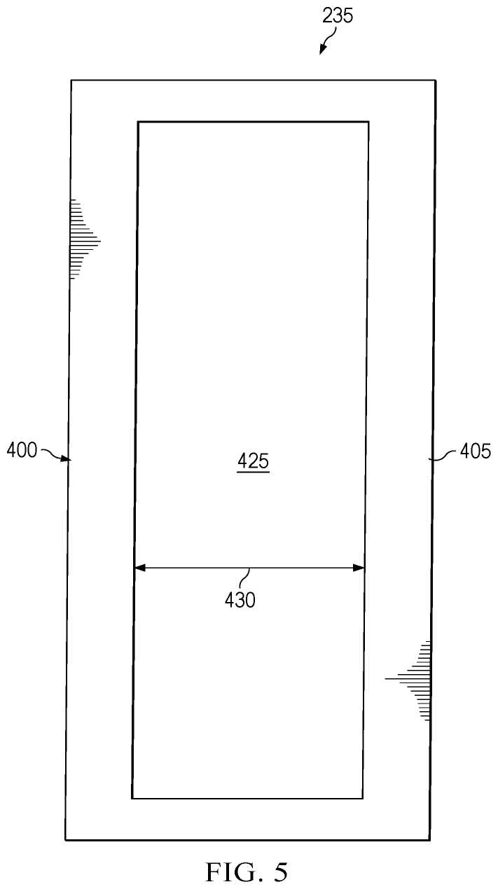

The waveguide 235 includes a generally wedge-shaped body 400 that is defined by a waveguide face, or front face, 405 and a rear face, or driver interface, 410. When installed, the front face 405 is oriented to face in the direction of the passenger cabin 200 and the driver interface 410 is used to couple the waveguide 235 to the driver 230. As shown, the front face 405 and the driver interface 410 are joined at an edge 415 of the body 400, such that the front face 405 extends away from the edge 415 at a tilt angle 420 relative to the driver interface 410. That is, the driver interface 410 of the waveguide 235 is separated from the front face 405 by the tilt angle 420. In some instances, the waveguide 235 is a slotted waveguide. In such instances a slot opening 425 (FIG. 5) is formed in the front face 405 of the waveguide 235 such that sound energy emitted by the driver 230 enters the passenger cabin 200 through the slot opening 425. In some instances, a width 430 of the slot opening 425 is determined based on the wavelengths corresponding to the desired frequency of sound waves emitted by the driver 230. Furthermore, it should be understood that the driver interface 410 is open to the driver 230 thereby allowing the driver 230 to couple to and emit sound energy through the waveguide 235.

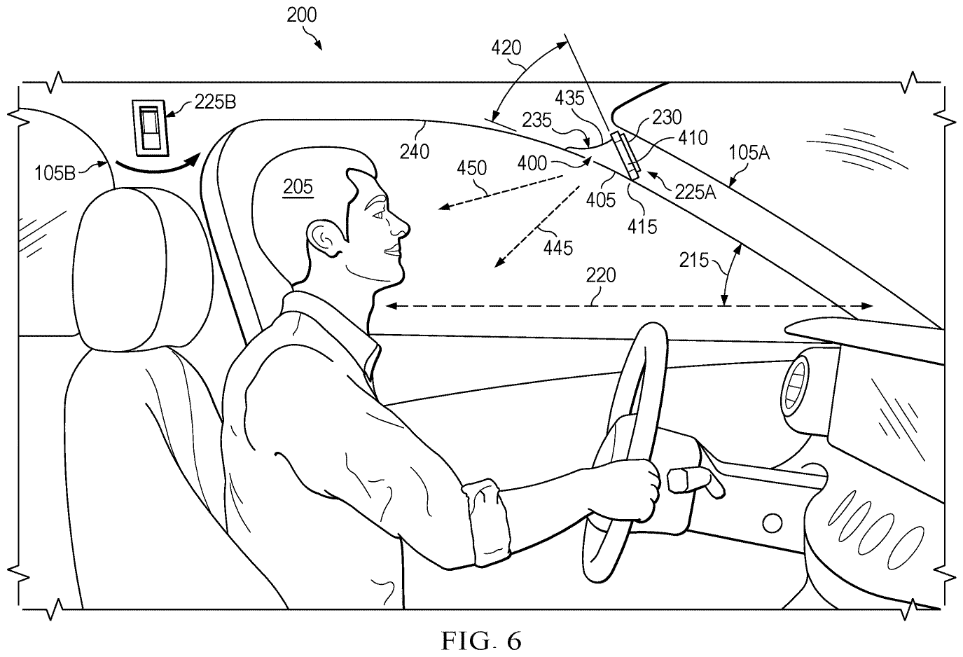

Referring back to FIG. 4, the body 400 further includes a top surface 435 that joins the extended edge of the front face 405 to the extended edge of the driver interface 410. That is, the top surface 435 extends between the end of the front face 405 that is opposite to the edge 415 and the end of the driver interface 410 that is opposite to the edge 415, thereby enclosing the side of body 400 opposite the edge 415. In the illustrated example of FIG. 4, the top surface 435 is relatively straight and/or flat. However, as will be described in more detail below, in some instances, the top surface 435 is arc-shaped. FIG. 6 illustrates an example side view of the passenger cabin 200 in which the top surface 435 of the waveguide 235 is arc-shaped. As shown, the arc of the top surface 435 is concave with respect to the waveguide body 400 such that the arc of the top surface 435 curves inward to the body 400. Advantages and design considerations for implementing the top surface 435 as an arc-shaped surface will be described in more detail below. Furthermore, hereinafter, when comparing one to the other, a waveguide 235 that includes a straight top surface 435 may be referred to as a “straight waveguide” and a waveguide that includes an arc-shaped top surface 435 may be referred to as an “arc-shaped waveguide.”

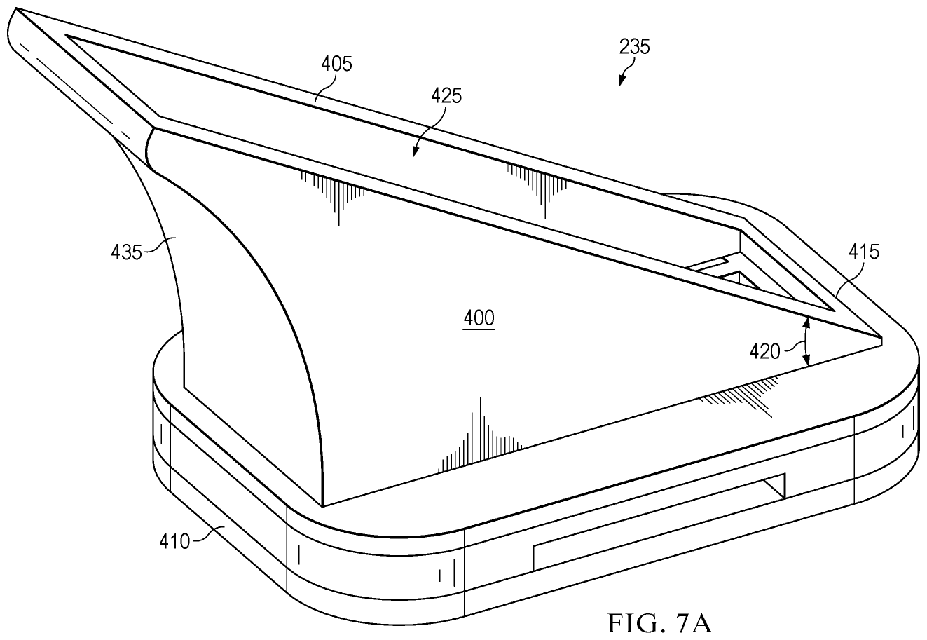

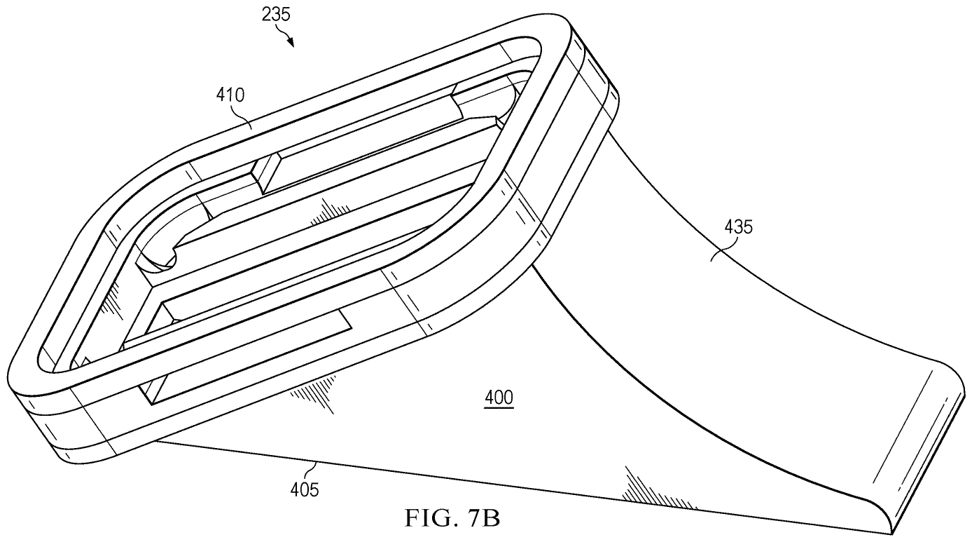

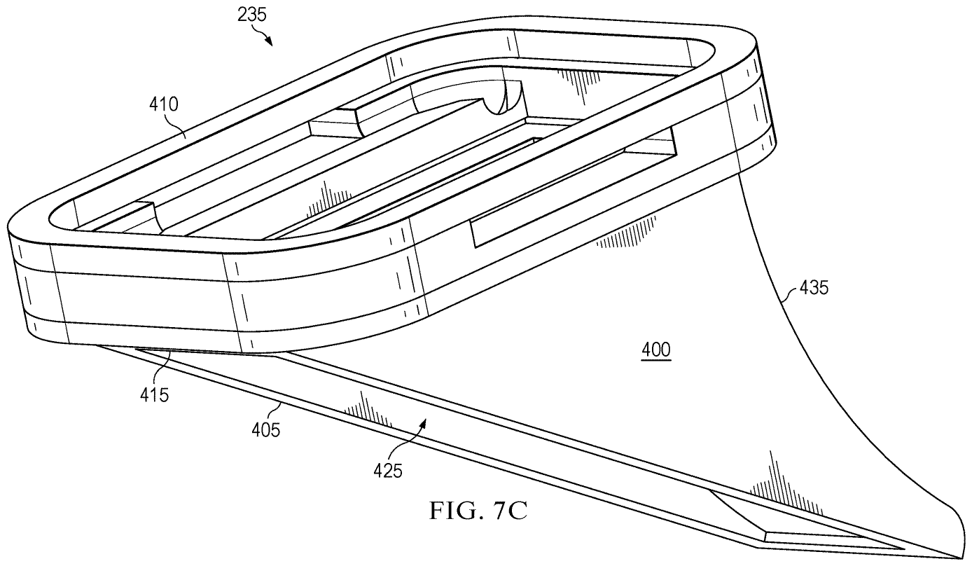

FIGS. 7A-7C illustrate various example perspective views of the waveguide 235 according to some aspects of the present disclosure. In the illustrated examples of FIGS. 7A-7C, the top surface 435 of the waveguide 235 is arc-shaped. FIG. 8 illustrates an example perspective view in which the driver 230 is coupled to the driver interface 410 according to some aspects of the present disclosure. As shown, the driver interface 405 is separated from the rest of the body 400 in FIG. 8 to illustrate an example of how the driver 230 may be coupled to the driver interface 410. In the illustrated example of FIG. 8, the driver 230 is a rectangular driver that is received by and seated within the driver interface 410. However, it should be understood that in some aspects, the driver 230 and/or the driver interface 410 have a different shape. Moreover, in some aspects, the driver 230 may be coupled to the driver interface 410 in a manner that is different than the manner illustrated in FIG. 8.

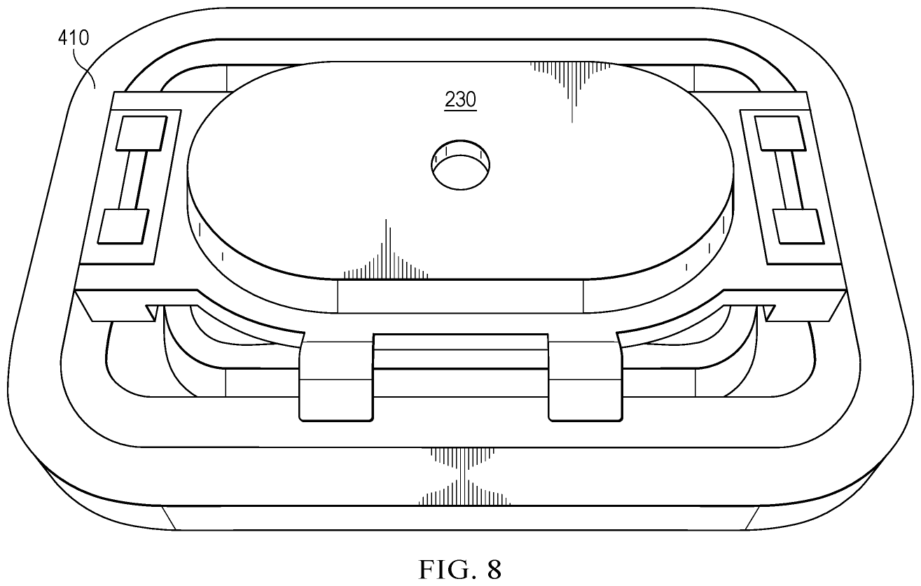

FIGS. 9A and 9B illustrate example perspective views in which the waveguide 235 includes flanges 440 for mounting the waveguide 235 to the vehicle pillars 105A-105C and/or the trim panel 240. As shown, the flanges 440 extend outward from and surround the slot opening 425 formed in the front face 405 of the waveguide 235. In some instances, the flanges 440 are secured to the pillars 105A-105C and/or the trim panel 240 using mechanical fasteners such as screws, pins, clips, or staples. In some instances, the flanges 440 are secured to the pillars 105A-105C and/or the trim panel 240 with adhesives and/or some other fastening method such as a friction fit. It should be understood that although the waveguide 235 includes flanges 440 for mounting the waveguide 235 to the pillars 105A-105C and/or the trim panel 240 in the illustrated example of FIGS. 9A and 9B, in some instances, the waveguide 235 may include other structures for mounting the waveguide 235 in addition to or in lieu of the flanges 400. For example, in some instances . . . .

Referring back to FIGS. 4 and 6, when the loudspeaker assembly 225A is installed on the A-pillar 105A, the front face 405 of the waveguide 235 is substantially flush with the trim panel 240. Therefore, the front face 405 of the waveguide 235 is oriented approximately in parallel with the A-pillar 105A and the trim panel 240 relative to the passenger cabin 200. As described above with respect to FIGS. 2 and 3, the A-pillar 105A and the trim panel 240 extend upward from the dashboard 210 at the first angle 215 relative to the passenger cabin 200, and thus, are oriented at the first angle 215 relative to the passenger 205. Since the front face 405 of the waveguide 235 is substantially parallel to the A-pillar 105A and the trim panel 240, the front face 405 is also oriented at the first angle 215 relative to the passenger 205. Accordingly, as the front face 405 of the waveguide 235 is oriented at the first angle 215 relative to the passenger 205, the front face 405 of the waveguide 235 is oriented to face in a first direction 445 relative to the passenger 205. The first direction 445 is approximately normal to the front face 405 of the waveguide 235, and thus, is also approximately normal to the A-pillar 105A and the trim panel 240.

As shown in FIGS. 4 and 6, the first direction 445 in which the front face 405 of the waveguide 235 faces is directed to a position that is below the listening position of the passenger 205 (e.g., below the passenger's head). Thus, to orient the driver 230 in a direction that is aimed more towards the listening position of the passenger 205, the driver interface 410 is tilted relative to the front face 405 by the tilt angle 420. Accordingly, since the driver 230 is coupled to the waveguide 235 by the driver interface 410, tilting the driver interface 410 relative to the front face 405 in effect tilts the driver 230 relative to the front face 405. Therefore, when the driver 230 is coupled to the waveguide 235 by the driver interface 410, the driver 230 is oriented to face in a second direction 450 relative to the passenger 205. As shown, the second direction 450 in which the driver 230 and driver interface 410 are oriented to face is aimed at the listening position of the passenger 205, not below the listening position of the passenger 205. The second direction 450 is approximately normal to the driver 230 and the driver interface 410. Moreover, since the driver interface 410 is tilted relative to the front face 405 by the tilt angle 420, the second direction 450 in which the driver 230 faces differs from the first direction 445 by the tilt angle 420. In some instances in which the loudspeaker assembly 225A is used to reproduce audio associated with height channels in a multi-channel audio system, the driver 230 may be tilted to face in a direction that is aimed above the listening position of the passenger 205.

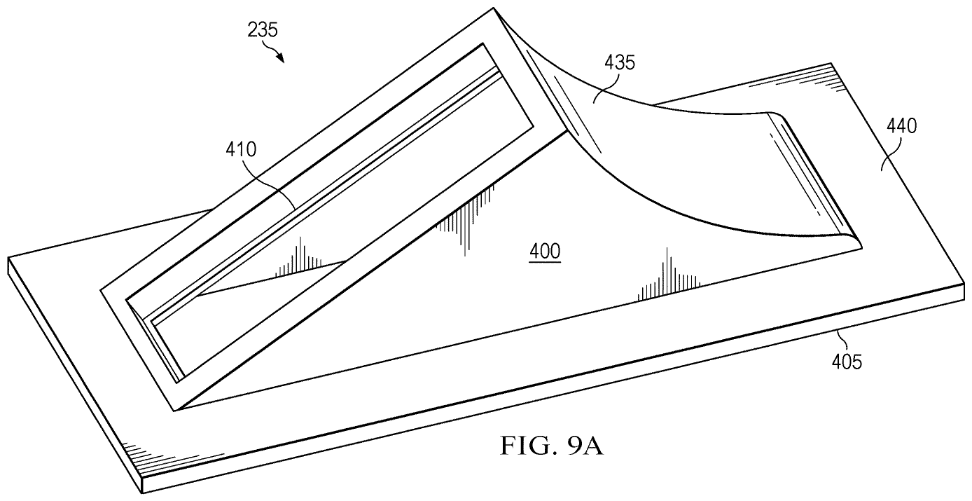

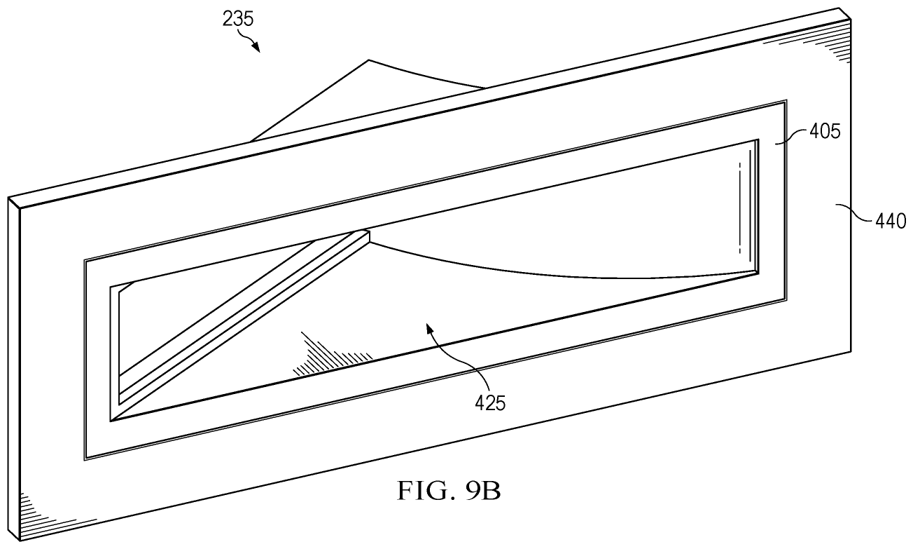

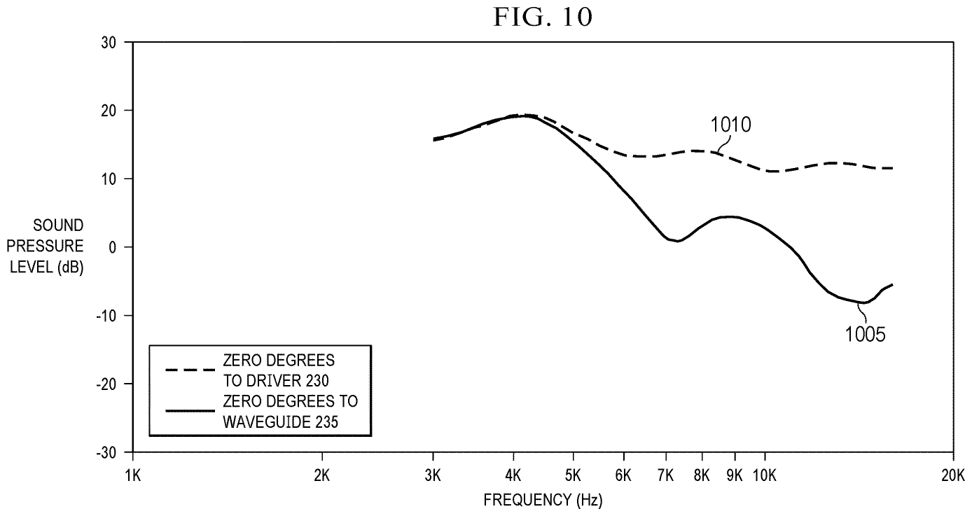

FIG. 10 illustrates the effect of the tilted waveguide 235 on the dispersion of sound energy emitted by the driver 230 into the passenger cabin 200. For example, FIG. 10 includes a first curve 1005 that depicts the sound pressure level, in decibels (dB), of sound energy radiating from the driver 230 in the first direction 445 below the listening position of the passenger 205 and a second curve 1010 that depicts the sound pressure level of sound radiating from the driver 230 in the second direction 450 towards the listening position of the passenger 205. That is, the first curve 1005 illustrates the sound pressure level within the passenger cabin 200 along an axis that is normal to the front face 405 of the waveguide 235 and the second curve 1010 illustrates the sound pressure level within the passenger cabin 200 along an axis that is normal to the driver 230. As shown, the pressure level of sound energy radiating in the second direction 450 towards the listening position of the passenger 205 is “brighter,” or stronger, than the pressure level of sound energy radiating in the first direction 445 below the listening position of the passenger 205. Therefore, the waveguide 235 that tilts the driver 230 to face in a direction towards the listening position of the passenger 205 (e.g., the second direction 450) causes a higher concentration of high frequency (e.g., 3 kHz-30 kHz) sound energy emitted by the driver 230 to be directed towards the listening position of the passenger 205 (e.g., the passenger's head) as opposed to below the listening position of the passenger 205.

As described above, in some instances the loudspeaker assembly 225A is used to emit sound energy associated with height channels in a multi-channel audio system. Thus, in such instances, the waveguide 235 may be designed to tilt the driver 230 to face in a direction above the listening position of the passenger 205. Accordingly, in such instances, the waveguide 235 causes a higher concentration of sound energy associated with the height channel(s) to presented at an elevation above the listening position of the passenger 205.

To improve control of the vertical and/or horizontal dispersion of sound energy radiating from the loudspeaker assembly 225, as described above, one or more geometric parameters of the waveguide 235 may be adjusted. Thus, when designing the waveguide 235, one or more of the tilt angle 420, the length of the front face 405 of the waveguide 235, the radius of the arc-shaped top surface 435, and other geometric parameters may be chosen such that the pressure level of high frequency sound energy emitted by the driver 230 is concentrated in the direction of the listening position of the passenger 205. In some instances, one or more of the geometric parameters of the waveguide 235 may be designed based in part on the angle (e.g., the first angle 215) at which the A-pillar 105 is oriented in the vehicle 100 in which the loudspeaker assembly 225 will be installed. In some instances, one or more of the geometric parameters of the waveguide 235 may be designed based on which of the pillars 105A-105C the loudspeaker assembly 225 will be installed on. For example, with reference to FIGS. 4 and 6, the geometric parameters of the waveguide 235 included in the loudspeaker assembly 225A installed on the A-pillar 105A may be designed to be different than the geometric parameters of the waveguide 235 included in the loudspeaker assembly 225B installed on the B-pillar 105B due to the orientation and location differences between the A and B pillars 105A, 105B. For instances in which the loudspeaker assembly 225A is used to emit sound energy associated with height channels in a multi-channel audio system, the geometric parameters of the waveguide 235 may be designed such that the pressure level of emitted sound energy associated with height channels is concentrated above the listening position of the passenger 205.

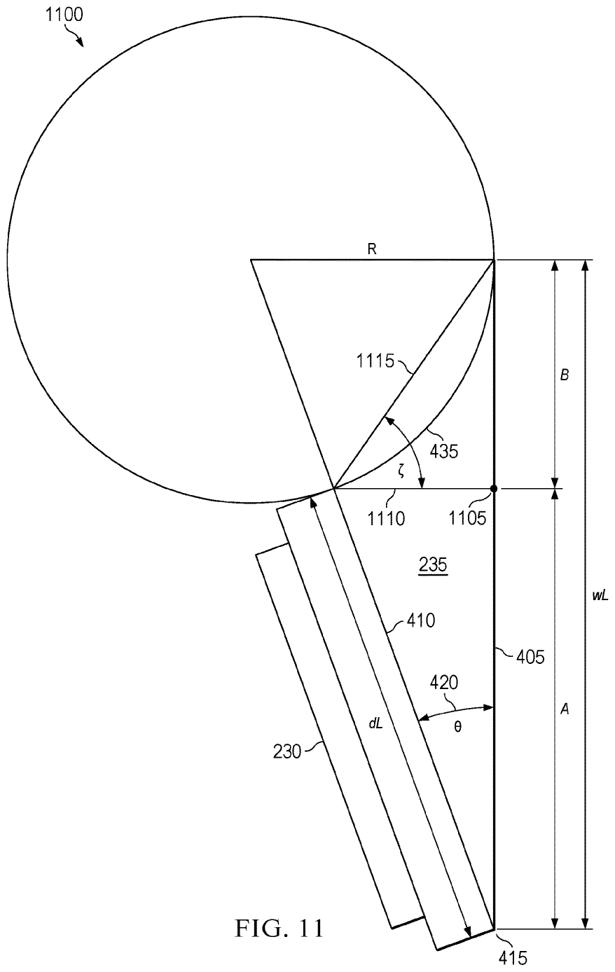

FIG. 11 is an example diagram 1100 that illustrates the geometric constraints, which are described below with respect to Equations 1-6, used to design the waveguide 235 according to some aspects of the present disclosure. As shown in the diagram 1100, the front face 405 of the waveguide 235 has a waveguide length wL and the driver 230 has a driver length dL. It should be understood that the length of the driver interface 410 is also approximately equal to the driver length dL, as the driver interface 410 is the component that couples the driver 230 to the waveguide 235. Moreover, it should be understood that the driver length dL is not a parameter that can be changed after the driver 230 included in the loudspeaker assembly 225 is selected. Thus, a practical manner in which the driver length dL can be adjusted when designing the waveguide 235 is to select a new driver that conforms to the desired driver length dL.

As shown in FIG. 11, when the top surface 435 is arc-shaped, the top surface 435 should designed to be tangent to the front face 405 at the point at which the top surface 435 is joined with the front face 405. Similarly, when the top surface 435 is arc-shaped, the top surface 435 should be designed such that the top surface 435 is perpendicular to the driver interface 410 at the point at which the top surface 435 is joined with the driver interface 410. To ensure that the top surface 435 is both tangent to the front face 405 of the waveguide 235 and perpendicular to the driver interface 410 of the waveguide 235, the radius R of an arc-shaped top surface 435 may be solved for using Equation 1 below. As described by Equation 1, the radius R of an arc-shaped top surface 435 is equal to the product of the length wL of the front face 405 and the tangent of the tilt angle 420. Thus, when values of the length wL of the front face 405 and the tilt angle 420 have been determined, it is possible to solve for the radius R of the arc-shaped top surface 435. It should be understood that Equation 1 can be rearranged to solve for the tilt angle 420 when values of the radius R and the length wL of the front face 405 have been determined. Similarly, it should be understood that Equation 1 can be rearranged to solve for the length wL of the front face 405 when values of the radius R and the tilt angle 420 have been determined.

R=wL*tan(θ) [Equation 1]

As further shown in FIG. 11, the length wL of the front face 405 of the waveguide 235 may be divided into an A component and a B component. That is, as expressed by Equation 2 below, the length wL of the front face 405 of the waveguide 235 may expressed as the sum of a first length A and a second length B.

wL=A+B [Equation 2]

As expressed below by Equation 3, the first length A is equal to the product of the cosine of the tilt angle 420 and the length dL of the driver 230. With respect to the diagram 1100, the first length A is the length of the portion of the of front face 405 that extends between the edge 415, at which the front face 405 and driver interface 410 are joined, and a point 1105 along the length wL. The point 1105 is the point along the length wL of front face 405 at which a line segment 1110 extending from the end of the driver interface 410 intersects the length wL of the front face 405 at a right angle.

A=cos(θ)*dL [Equation 3]

As expressed below by Equation 4, the second length B is equal to the product of the sine of the tilt angle 420, the driver length dL, and the tangent of an angle Zeta. As expressed below by Equation 5, the angle Zeta is a function of the tilt angle 420. With respect to the diagram 1100, the angle Zeta is the angle between the line segment 1110 and a line segment 1115 that extends between the end of the driver interface 410 and the end of the front face 405. Moreover, with respect to the diagram 1100, the second length B is the length of the portion of the of front face 405 that extends between the point 1105 and the end of the front face 405 that is joined with the top surface 435.

$$B = sin ( θ ) * d L * tan ( ζ ) \qquad [ Equation 4 ]$$

$$ζ = \frac{180 - ( 90 - θ )}{2} \qquad [ Equation 5 ]$$

When Equations 2-5 are combined into a single expression, as shown by Equation 6 below, the length wL of the front face 405 of the waveguide 235 can be solved for as a function of the tilt angle 420 and the length dL of the driver 230. It should be understood that Equation 6 could be rearranged to solve for the tilt angle 420 when the length wL of the front face 405 and the length dL of the driver 230 have been determined.

$$w L = cos ( θ ) * d L + sin ( θ ) * d L * tan ( \frac{180 - ( 90 - θ )}{2} ) \qquad [ Equation 6 ]$$

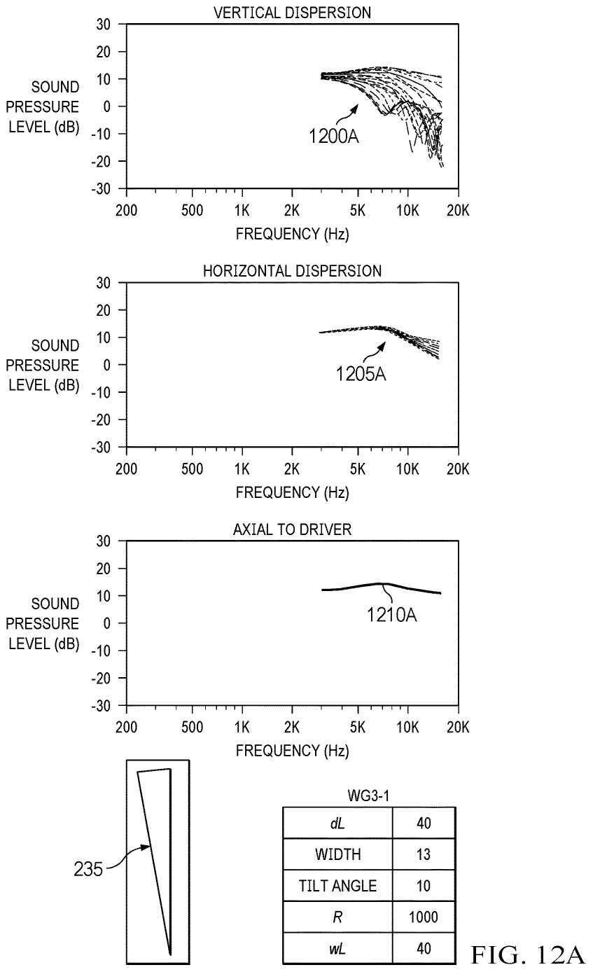

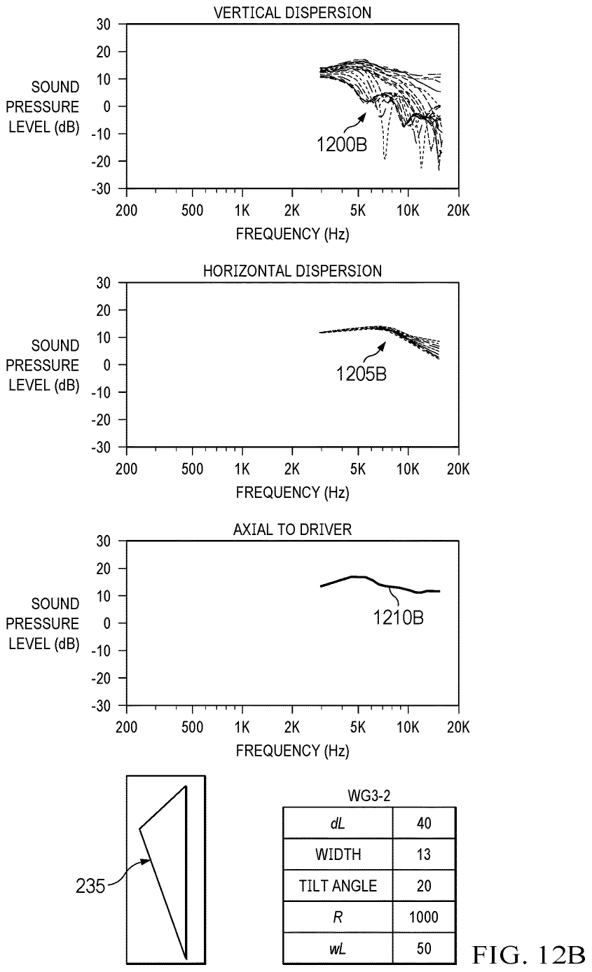

Accordingly, Equations 1-6 provided above can be used to design and/or solve for various geometric parameters of the waveguide 235. As will be described below with respect to FIGS. 12-16, adjusting values of one or more geometric parameters of the waveguide 235 may affect change in the horizontal and/or vertical dispersion of sound energy emitted by the driver 230.

FIGS. 12A-12D illustrate the effect that adjusting the tilt angle 420 has on the vertical and horizontal dispersion of sound energy emitted by the driver 230 when the waveguide 235 coupled to the driver 230 is a straight waveguide (e.g., the top surface 435 is straight, not arc-shaped). For example, FIG. 12A illustrates the vertical dispersion 1200A of sound energy emitted by the driver 230, the horizontal dispersion 1205A of sound energy emitted by the driver 230, and the dispersion 1210A of sound energy emitted by the driver 230 along an axis that is normal to the driver 230 (e.g., in the second direction 450 towards the listening position of the passenger 205) when a straight waveguide 235 having a tilt angle 420 of 10 degrees is coupled to the driver 230. FIG. 12B illustrates the vertical dispersion 1200B of sound energy emitted by the driver 230, the horizontal dispersion 1205B of sound energy emitted by the driver 230, and the dispersion 1210B of sound energy emitted by the driver 230 along an axis that is normal to the driver 230 when a straight waveguide 235 having a tilt angle 420 of 20 degrees is coupled to the driver 230. Similarly, FIG. 12C illustrates the vertical dispersion 1200C of sound energy emitted by the driver 230, the horizontal dispersion 1205C of sound energy emitted by the driver 230, and the dispersion 1210C of sound energy emitted by the driver 230 along an axis that is normal to the driver 230 when a straight waveguide 235 having a tilt angle 420 of 30 degrees is coupled to the driver 230. Moreover, FIG. 12D illustrates the vertical dispersion 1200D of sound energy emitted by the driver 230, the horizontal dispersion 1205D of sound energy emitted by the driver 230, and the dispersion 1210D of sound energy emitted by the driver 230 along an axis that is normal to the driver 230 when a straight waveguide 235 having a tilt angle 420 of 40 degrees is coupled to the driver 230.

As shown, the vertical dispersion of sound energy at high frequencies becomes less controlled, or more scattered, as the tilt angle 420 is increased from 10 degrees to 40 degrees and the top surface 435. Accordingly, an arc-shaped top surface 435 may be added to the waveguide 235 to improve control of the vertical dispersion of sound energy.

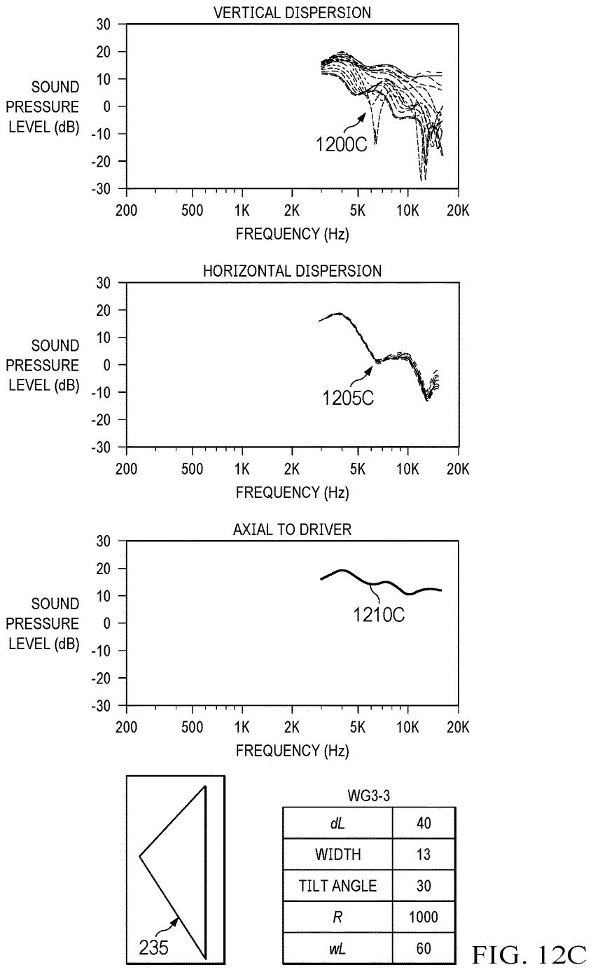

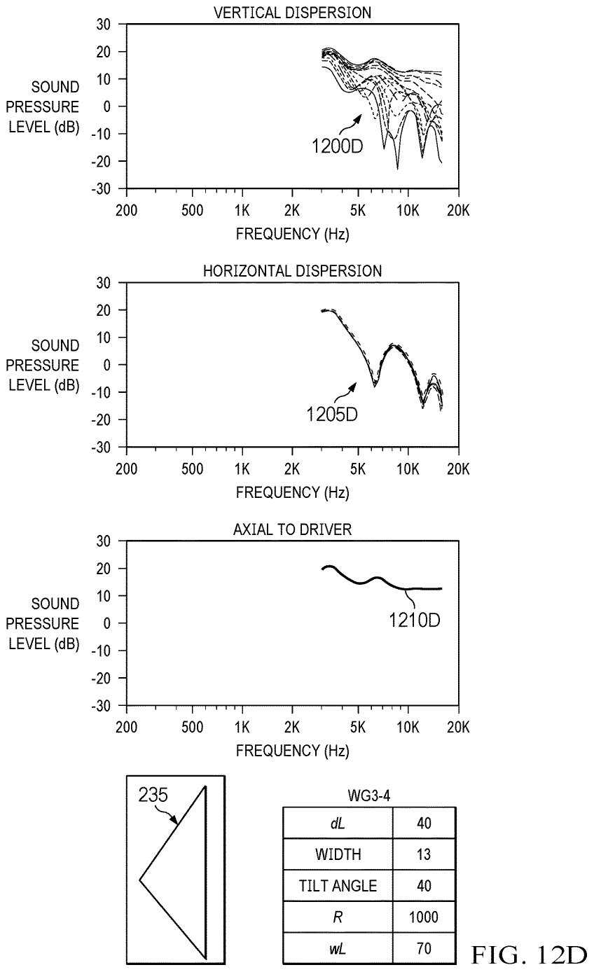

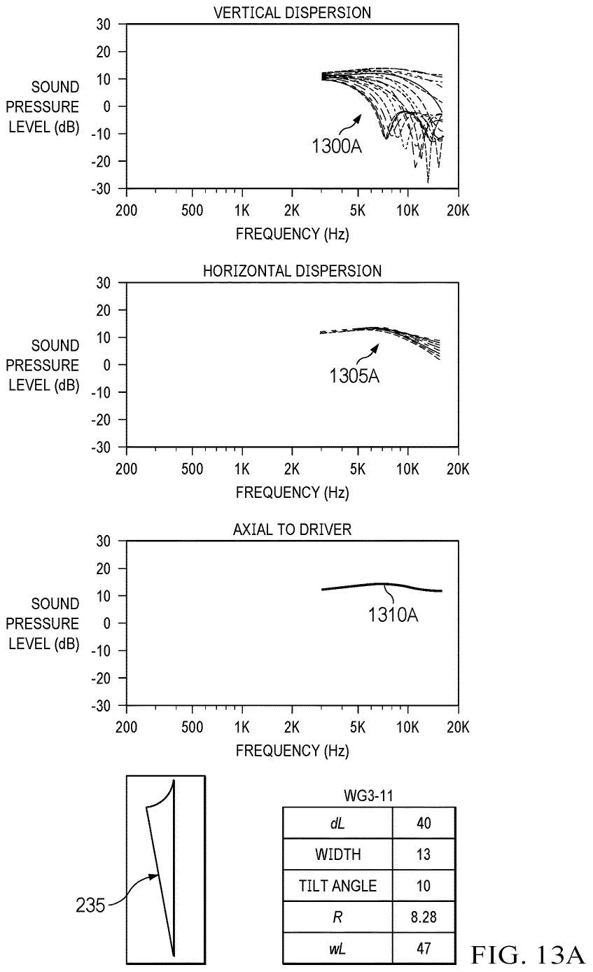

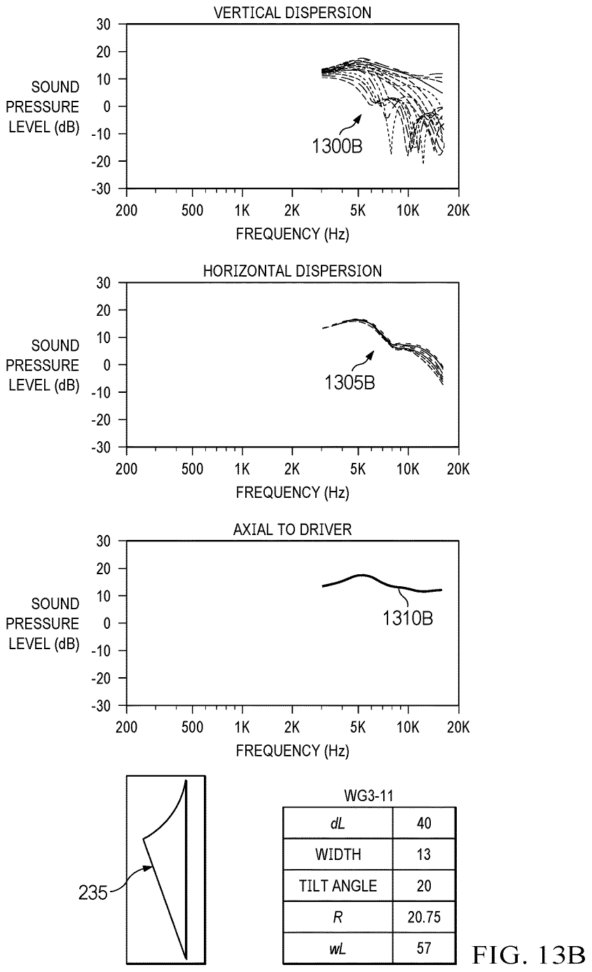

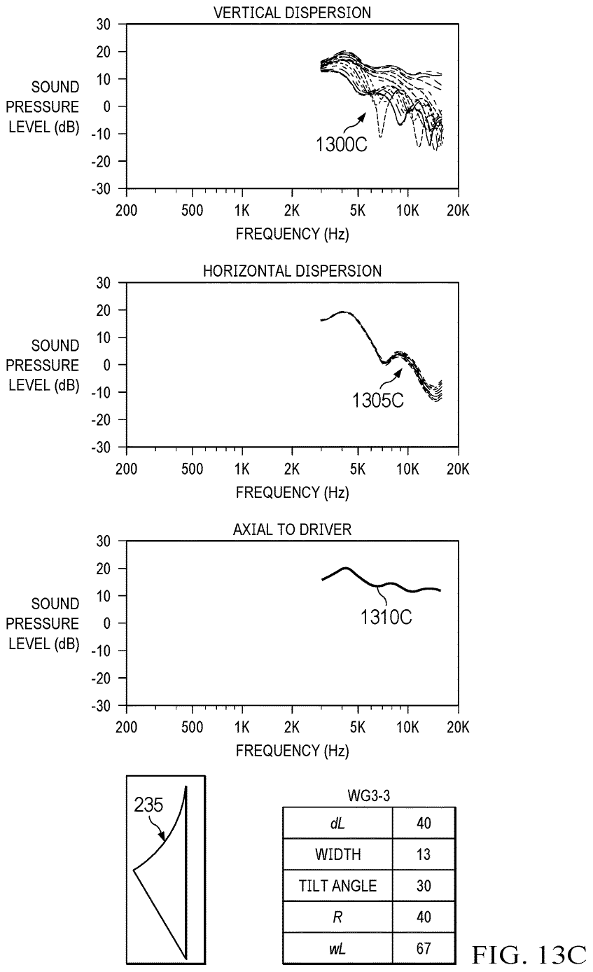

FIGS. 13A-13D illustrate the effect that adjusting the tilt angle 420 has on the vertical and horizontal dispersion of sound energy emitted by the driver 230 when the waveguide 235 coupled to the driver 230 is an arc-shaped waveguide (e.g., the top surface 435 is arc-shaped, not straight). For example, FIG. 13A illustrates the vertical dispersion 1300A of sound energy emitted by the driver 230, the horizontal dispersion 1305A of sound energy emitted by the driver 230, and the dispersion 1310A of sound energy emitted by the driver 230 along an axis that is normal to the driver 230 (e.g., in the second direction 450 towards the listening position of the passenger 205) when an arc-shaped waveguide 235 having a tilt angle 420 of 10 degrees is coupled to the driver 230. FIG. 13B illustrates the vertical dispersion 1300B of sound energy emitted by the driver 230, the horizontal dispersion 1305B of sound energy emitted by the driver 230, and the dispersion 1310B of sound energy emitted by the driver 230 along an axis that is normal to the driver 230 when an arc-shaped waveguide 235 having a tilt angle 420 of 20 degrees is coupled to the driver 230. Similarly, FIG. 13C illustrates the vertical dispersion 1300C of sound energy emitted by the driver 230, the horizontal dispersion 1305C of sound energy emitted by the driver 230, and the dispersion 1310C of sound energy emitted by the driver 230 along an axis that is normal to the driver 230 when an arc-shaped waveguide 235 having a tilt angle 420 of 30 degrees is coupled to the driver 230. Moreover, FIG. 13D illustrates the vertical dispersion 1300D of sound energy emitted by the driver 230, the horizontal dispersion 1305D of sound energy emitted by the driver 230, and the dispersion 1310D of sound energy emitted by the driver 230 along an axis that is normal to the driver 230 when an arc-shaped waveguide 235 having a tilt angle 420 of 40 degrees is coupled to the driver 230.

As shown, the vertical dispersions 1300B, 1300C of high frequency sound energy is relatively more controlled, or less scattered, when driver 230 is coupled to an arc-shaped waveguide 235 having a tilt angle 420 of 20 degrees or 30 degrees than when compared to the vertical dispersions 1300A, 1300D of high frequency sound pressure when driver 230 is coupled to an arc-shaped waveguide 235 having a tilt angle 420 of 10 degrees or 40 degrees. Moreover, when comparing the sound energy dispersion graphs of FIGS. 12A-12D to the respective sound energy dispersion graphs of FIGS. 13A-13D, it is clear that vertical dispersion of sound energy emitted by a driver 230 coupled to an arc-shaped waveguide 235 is generally more controlled at higher frequencies than the vertical dispersion of sound energy emitted by a driver 230 coupled to a straight waveguide 235, regardless of the value of tilt angle 420. That is, a waveguide 235 that has an arc-shaped top surface 435 is more effective in controlling the vertical dispersion of high frequency sound energy emitted by the driver 230 than a waveguide that has a straight top surface 435.

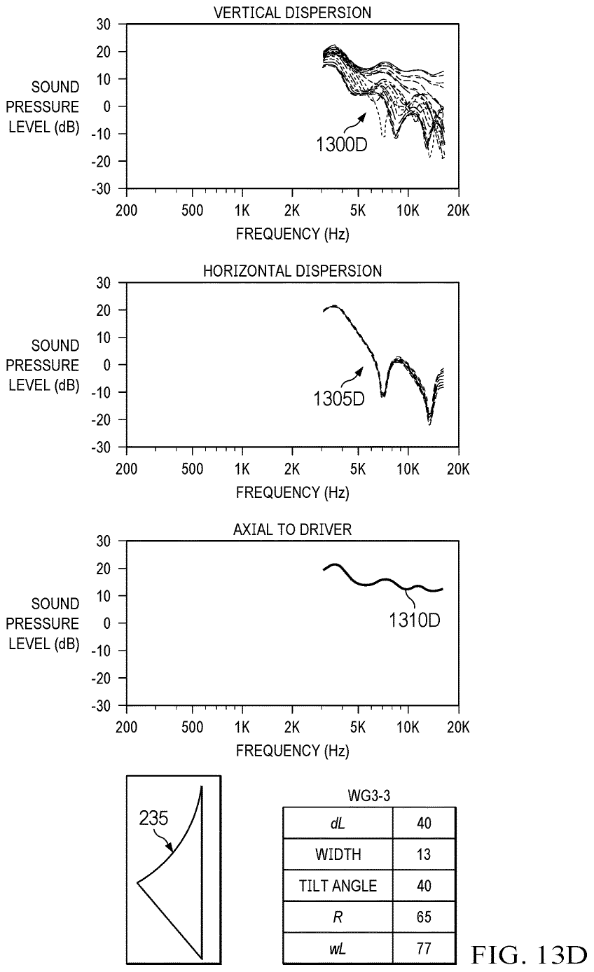

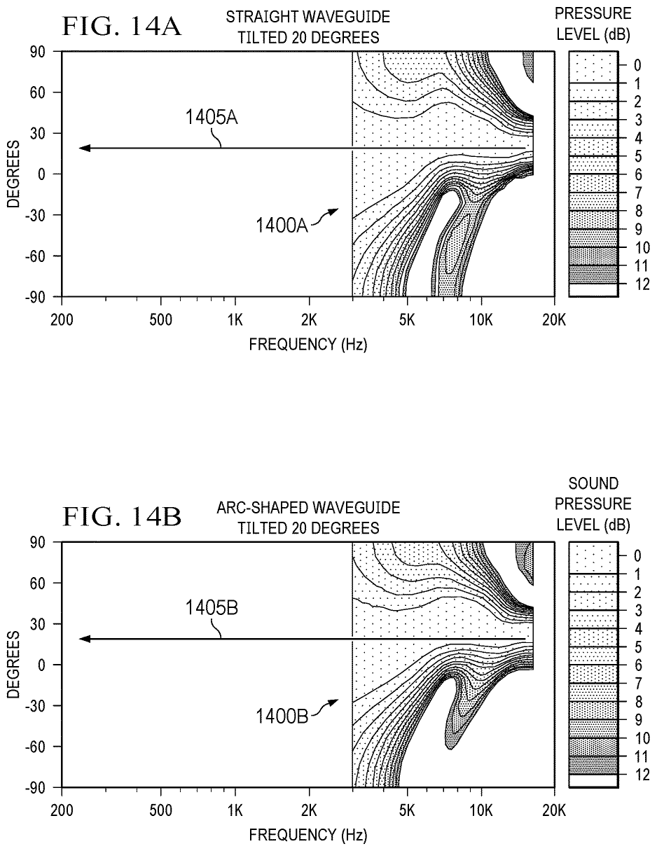

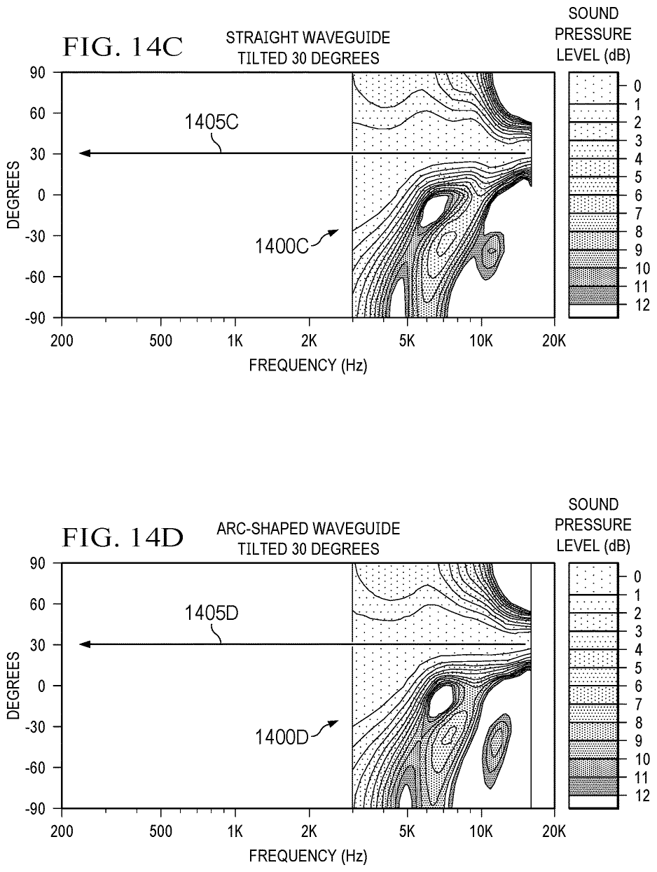

FIGS. 14A-14D illustrate sound pressure contours that more clearly depict the improved vertical directivity of sound energy emitted by a driver 230 coupled to a waveguide 235 having an arc-shaped top surface 435. For example, FIG. 14A is a first contour 1400A that illustrates the vertical directivity of sound energy emitted by a driver 230 coupled to a straight waveguide 235 having a 20 degree tilt angle 420. By comparison, FIG. 14B is a second contour 1400B that illustrates the vertical directivity of sound energy emitted by a driver 230 coupled to an arc-shaped waveguide 235 having a 20 degree tilt angle 420. As shown by the second contour 1400B, there is less variation in the pressure level of sound energy emitted along an axis 1405B that is normal to the driver 230 when the driver 230 is coupled to a waveguide 235 having an arc-shaped top surface 435. That is, when compared to the first contour 1400A depicting the vertical dispersion of the sound energy emitted by the driver 230 coupled to a straight waveguide 235 having a 20 degree tilt angle 420, the second contour 1400B shows that sound energy emitted by the driver 230 along an axis from the driver 230 towards the listening position of the passenger 205 (e.g., in the second direction 450) is more controlled and highly concentrated. Furthermore, the second contour 1400B shows that the amount, or concentration, of down-firing sound energy (e.g., directed below the listening position of the passenger 235) emitted by the driver 230 is reduced when the waveguide 235 has an arc-shaped top surface 435.

Similar effects are demonstrated by the comparison between FIG. 14C, which illustrates a third contour 1400C that shows the vertical directivity of sound energy emitted by a driver 230 coupled to a straight waveguide 235 having a 30 degree tilt angle 420, and FIG. 14D, which illustrates a fourth contour 1400D that show the vertical directivity of sound energy emitted by a driver 230 coupled to an arc-shaped waveguide 235 having a 30 degree tilt angle 420.

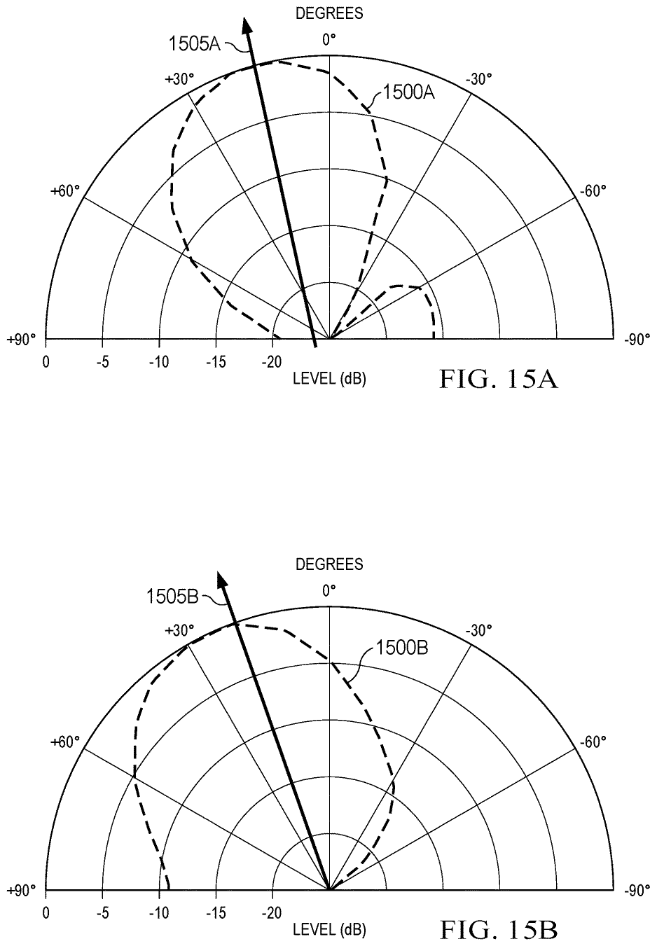

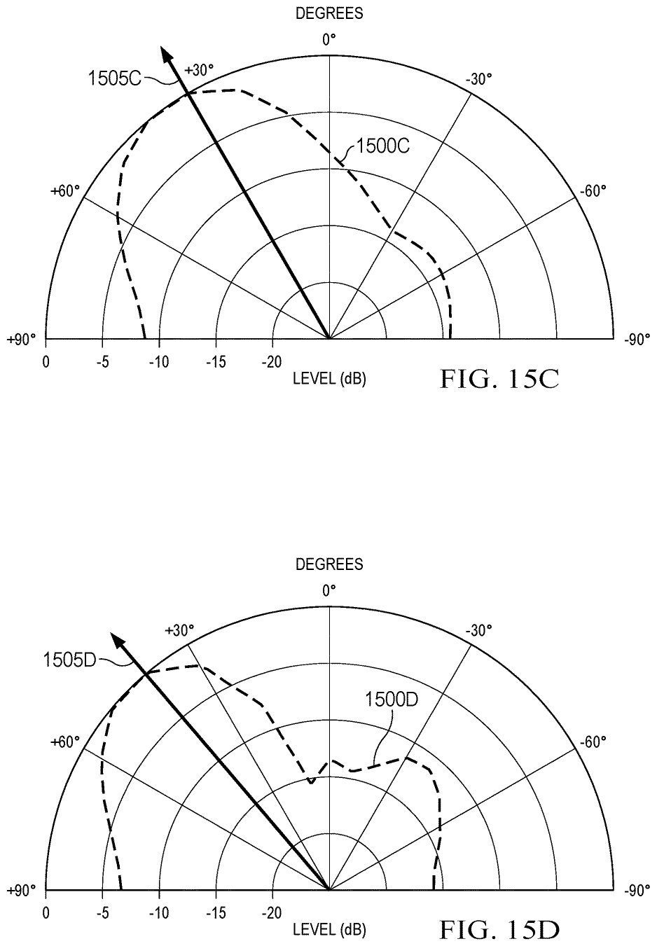

As yet another example depiction of the benefits of coupling the driver 230 to a tilted arc-shaped waveguide 235, FIGS. 15A-15D provide polar charts that respectively illustrate the controlled dispersion of emitted sound energy along an axis that is normal to the driver 230. In the illustrated examples of FIGS. 15A-15D, the depicted sound energy dispersions have a frequency of 10 kHz. FIG. 15A illustrates the dispersion 1500A of emitted sound energy along an axis 1505A that is normal to a driver 230 coupled to an arc-shaped waveguide 235 having a tilt angle of 10 degrees (e.g., the driver 230 is tilted at 10 degrees). FIG. 15B illustrates the dispersion 1500B of emitted sound energy along an axis 1505B that is normal to a driver 230 coupled to an arc-shaped waveguide 235 having a tilt angle of 20 degrees (e.g., the driver 230 is tilted at 20 degrees). FIG. 15C illustrates the dispersion 1500C of emitted sound energy along an axis 1505C that is normal to a driver 230 coupled to an arc-shaped waveguide 235 having a tilt angle of 30 degrees (e.g., the driver 230 is tilted at 30 degrees). FIG. 15D illustrates the dispersion 1500D of emitted sound energy along an axis 1505D that is normal to a driver 230 coupled to an arc-shaped waveguide 235 having a tilt angle of 40 degrees (e.g., the driver 230 is tilted at 40 degrees). As shown in FIGS. 15A-15D, tilting the driver 230 by the tilt angle 420 of the waveguide 235 towards the listening position of the passenger 205 concentrates the dispersion of high frequency (e.g., 10 kHz) sound energy along the axis 1505 that is normal to the driver 230. That is, tilting the driver 230 increases the concentration of high frequency sound energy emitted in a direction (e.g., the second direction 450) towards the passenger's listening position while also reducing the concentration of high frequency sound energy that is emitted in a direction (e.g., the first direction 445) that is below the passenger's listening position.

Although the width 430 of the slot opening 425 formed in the front face 405 of the waveguide 235 was not described above with Equations 1-6 used for designing the geometric parameters of the waveguide 235, the value of the width 430 of the slot opening 425 should also be considered when designing the waveguide 235. In general, designing the width 430 of the slot opening 425 to be much less than the length wL of the front face 405 and less than the length dL of the driver 230 improves the horizontal directivity of sound energy emitted by the driver 230. That is, narrowing the width 430 of the slot opening 425 results in high horizontal dispersion of sound energy within the passenger cabin 200. Furthermore, narrowing the width 430 of the slot opening 425 reduces the amount of damping, such as radiation damping, because of the smaller area through which sound energy emitted by the driver 230 exits the waveguide.

Despite the above-described benefits of narrowing the width 430 of the slot opening 425, a few undesirable effects may result when the width 430 is made too narrow. For example, narrowing the width 430 of the slot opening 425 too much may present challenges when coupling the waveguide 235 to a wide driver 230. Furthermore, in some instances, narrowing the width 430 of the slot opening 425 by too much may increase the ripple frequency of the loudspeaker assembly 225.

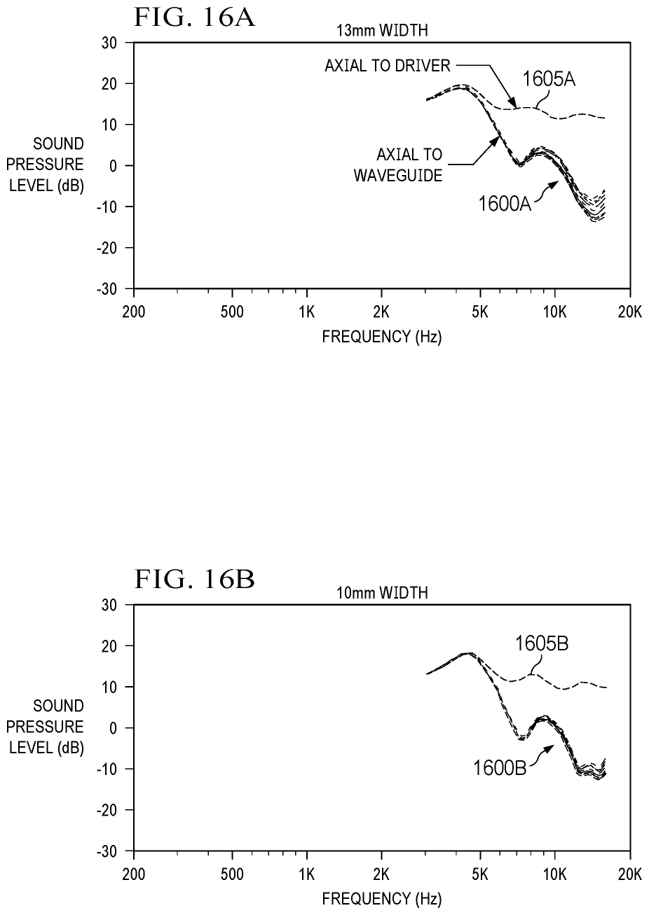

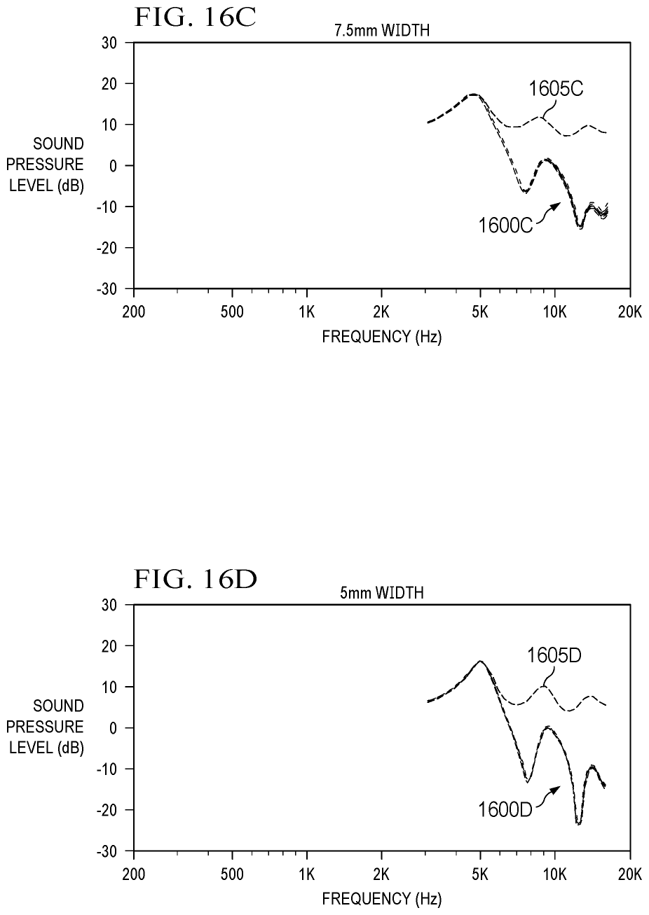

FIGS. 16A-16D illustrate the effect that adjusting the width 430 of the slot opening 425 has on the dispersion of sound energy emitted by the driver 230 along an axis normal to the front face 405 of the waveguide 235 (e.g., in the first direction 445) and along an axis normal to the driver 230 (e.g., in the second direction 450). For example, FIG. 16A illustrates the horizontal dispersion 1600A of sound energy radiating from the driver 230 in the first direction 445 below the listening position of the passenger 205 and the horizontal dispersion 1605A of sound energy radiating from the driver 230 in the second direction 450 towards the listening position of the passenger 205, wherein the driver 230 is coupled to a waveguide 235 in which the width 430 of the slot opening 425 is 13 millimeters (mm). FIG. 16B illustrates the horizontal dispersion 1600B of sound energy radiating from the driver 230 in the first direction 445 below the listening position of the passenger 205 and the horizontal dispersion 1605B of sound energy radiating from the driver 230 in the second direction 450 towards the listening position of the passenger 205, wherein the driver 230 is coupled to a waveguide 235 in which the width 430 of the slot opening 425 is 10 mm. FIG. 16C illustrates the horizontal dispersion 1600C of sound energy radiating from the driver 230 in the first direction 445 below the listening position of the passenger 205 and the horizontal dispersion 1605C of sound energy radiating from the driver 230 in the second direction 450 towards the listening position of the passenger 205, wherein the driver 230 is coupled to a waveguide 235 in which the width 430 of the slot opening 425 is 7.5 mm. FIG. 16D illustrates the horizontal dispersion 1600D of sound energy radiating from the driver 230 in the first direction 445 below the listening position of the passenger 205 and the horizontal dispersion 1605D of sound energy radiating from the driver 230 in the second direction 450 towards the listening position of the passenger 205, wherein the driver 230 is coupled to a waveguide 235 in which the width 430 of the slot opening 425 is 5 mm.

Loudspeaker assemblies including the tilted waveguide described herein provide for an improved listening experience for passengers 205 riding in a vehicle 100. However, it should be understood that even though the loudspeaker assemblies 225, drivers 230, and/or waveguides 235 described herein were primarily described as being implemented in a vehicle 100, the loudspeaker assemblies 225, drivers 230, and/or waveguides 235 described herein may also be implemented in other applications in which the elevation and/or location of the sound stage may be adjusted. For example, the waveguides 235 described herein may be used with television speakers, speakers in a home theater, cinema speakers, speakers in a concert venue, and/or other speakers to adjust the position of a listening environment's sound stage. Moreover, the waveguides 235 described herein may be used with television speakers, speakers in a home theater, cinema speakers, speakers in a concert venue, and/or other speakers to better control the vertical and/or horizontal dispersion of sound energy emitted by such speakers.

Furthermore, as described above, the loudspeaker assemblies 225, drivers 230, and/or waveguides 235 described herein may be implemented in multi-channel audio systems and/or products. For example, the loudspeaker assemblies 225, drivers 230, and/or waveguides 235 may be implemented in 360 degree loudspeakers, soundbars, televisions, home theaters, and/or other multi-channel audio products and/or systems. In such instances, the waveguides 235 described herein may be coupled to drivers 230 that are used to output height channel audio. Accordingly, in such instances, the waveguides 235 is used to steer and/or reproduce the height channel audio emitted by a driver 230 at an intended source location (e.g., at a position above the ear level of a listener/viewer). As an example, when a waveguide 235 is coupled to a driver 230 used for emitting sound energy associated with a height channel is included in a device, such as a soundbar or a television, the waveguide 235 steers the emitted sound energy such that the height channel audio output by the driver 230 appears to arrive from an elevated position above the ear level of a listener/viewer. In some instances, the loudspeaker assemblies 225, drivers 230, and/or waveguides 235 described herein are used to increase lateral spaciousness/directivity instead of or in addition to vertical directivity.

### Effects

Systems, methods, and devices in accordance with the present disclosure may take any one or more of the following configurations.
(1) A loudspeaker assembly including a wedge-shaped acoustic waveguide and an audio driver. The wedge-shaped acoustic waveguide includes a first face including a slot opening formed therein, a second face joined at an edge with the first face, the second face tilted relative to the first face by a first angle, and a surface disposed opposite the edge and connected between the first face and the second face. The audio driver is coupled to the second face such that the audio driver is tilted at the first angle relative to the first face.
(2) The loudspeaker assembly according to (1), wherein the surface is arc-shaped.
(3) The loudspeaker assembly according to (2), wherein the surface is tangent to the first face and perpendicular to the second face.
(4) The loudspeaker assembly according to (2), wherein a radius of the arc-shaped surface is a function of a length of the first face and a tangent of the first angle.
(5) The loudspeaker assembly according to any one of (1) to (4), wherein a length of the first face is a function of a length of the second face and the first angle.
(6) The loudspeaker assembly according to any one of (1) to (5), wherein the first face is oriented to face in a first direction and the audio driver is oriented to face in a second direction and, wherein a pressure level of sound energy emitted by the audio driver is greater along the second direction than the first direction.
(7) The loudspeaker assembly according to any one of (1) to (6), wherein the wedge-shaped acoustic waveguide further includes a structural component used for installing the loudspeaker assembly on a pillar of a vehicle.
(8) An acoustic waveguide for use with an audio driver including a wedge-shaped body, a first face including a slot opening formed therein, a second face joined at an edge with the first face, the second face tilted relative to the first face by a first angle and configured to couple the audio driver to the acoustic waveguide, and a surface disposed opposite the edge and connected between the first face and the second face.
(9) The acoustic waveguide according to (8), wherein the surface is arc-shaped.
(10) The acoustic waveguide according to (9), wherein the surface is tangent to the first face and perpendicular to the second face.
(11) The acoustic waveguide according to (9), wherein a radius of the arc-shaped surface is a function of a length of the first face and a tangent of the first angle.
(12) The acoustic waveguide according to any one of (8) to (11), wherein a length of the first face is a function of a length of the second face and the first angle.
(13) The acoustic waveguide according to any one of (8) to (12), wherein the first face is oriented to face in a first direction and the audio driver is oriented to face in a second direction, and wherein when the audio driver is coupled to the second face, a pressure level of sound energy emitted by the audio driver is greater along the second direction than the first direction.
(14) The acoustic waveguide according to any one of (8) to (13), further including a structural component used for installing the acoustic waveguide on a pillar of a vehicle.
(15) A vehicle including a passenger cabin, a pillar extending upwards at a first angle relative to the passenger cabin, and a loudspeaker assembly installed on the pillar. The loudspeaker assembly includes a wedge-shaped acoustic waveguide including a first face including a slot opening formed therein, a second face joined at an edge with the first face, the second face tilted relative to the first face by a second angle, and a surface disposed opposite the edge and connected between the first face and the second face. The loudspeaker assembly further includes an audio driver coupled to the second face such that the audio driver is tilted at the second angle relative to the first face.
(16) The vehicle according to (15), further including a trim panel coupled to the pillar and wherein the loudspeaker assembly is disposed between the pillar and the trim panel.
(17) The vehicle according to (16), wherein the first face flush with a surface of the trim panel.
(18) The vehicle according to any one of (15) to (17), wherein the first face is oriented to face in a first direction towards the passenger cabin and the audio driver is oriented to face in a second direction towards the passenger cabin, and wherein a pressure level of sound energy emitted by the audio driver is greater along the second direction than the first direction.
(19) The vehicle according to any one of (15) to (18), wherein the surface is arc-shaped.
(20) The vehicle according to (19), wherein the surface is tangent to the first face and perpendicular to the second face.
(21) The vehicle according to any one of (19) to (20), wherein a radius of the arc-shaped surface is a function of a length of the first face and a tangent of the first angle.
(22) The vehicle according to any one of (19) to (21), wherein a length of the first face is a function of a length of the second face and the first angle.

It is to be understood that the above description is intended to be illustrative and not restrictive. Many instances and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future instances. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various instances for the purpose of streamlining the disclosure. This method of disclosure is not to be interpreted as reflecting an intention that the claimed instances incorporate more features than are expressly recited in each claim. Rather, as the following claims reflect, inventive subject matter lies in less than all features of a single disclosed instance. Thus the following claims are hereby incorporated into the Detailed Description, with each claim standing on its own as a separately claimed subject matter.

1-19. (canceled)

20. A loudspeaker assembly comprising:
a wedge-shaped acoustic waveguide including:
a first face including a slot opening formed therein;
a second face joined at an edge with the first face, the second face tilted relative to the first face by a first angle; and
a surface disposed opposite the edge and connected between the first face and the second face, wherein the surface is arc-shaped, wherein the surface is tangent to the first face at the point at which the surface is joined with the first face, and perpendicular to the second face at the point at which the surface is joined with the second face; and
an audio driver coupled to the second face such that the audio driver is tilted at the first angle relative to the first face, wherein the first face is oriented to face in a first direction and the audio driver is oriented to face in a second direction; and
wherein a pressure level of sound energy emitted by the audio driver is greater along the second direction than the first direction.

21. The loudspeaker assembly according to claim 20, wherein a radius of the arc-shaped surface is a function of a length of the first face and a tangent of the first angle.

22. The loudspeaker assembly according to claim 20, wherein a length of the first face is a function of a length of the second face and the first angle.

23. The loudspeaker assembly according to claim 20, wherein the wedge-shaped acoustic waveguide further includes a structural component used for installing the loudspeaker assembly on a pillar of a vehicle.

24. A vehicle comprising:
a passenger cabin;
a pillar extending upwards at a first angle relative to the passenger cabin; and
a loudspeaker assembly installed on the pillar, the loudspeaker assembly including:
a wedge-shaped acoustic waveguide including:
a first face including a slot opening formed therein;
a second face joined at an edge with the first face, the second face tilted relative to the first face by a second angle; and
a surface disposed opposite the edge and connected between the first face and the second face, wherein the surface is arc-shaped, wherein the surface is tangent to the first face at the point at which the surface is joined with the first face, and perpendicular to the second face at the point at which the surface is joined with the second face; and
an audio driver coupled to the second face such that the audio driver is tilted at the second angle relative to the first face, wherein the first face is oriented to face in a first direction towards the passenger cabin and the audio driver is oriented to face in a second direction towards the passenger cabin; and
wherein a pressure level of sound energy emitted by the audio driver is greater along the second direction than the first direction.

25. The vehicle of according to claim 24, further comprising a trim panel coupled to the pillar; and
wherein the loudspeaker assembly is disposed between the pillar and the trim panel.

26. The vehicle according to claim 25, wherein the first face is flush with a surface of the trim panel.

27. The vehicle according to claim 24, wherein a radius of the arc-shaped surface is a function of a length of the first face and a tangent of the first angle.

28. The vehicle according to claim 24, wherein a length of the first face is a function of a length of the second face and the first angle.

29. An acoustic waveguide for use with an audio driver comprising:
a wedge-shaped body;
a first face including a slot opening formed therein;
a second face joined at an edge with the first face, the second face tilted relative to the first face by a first angle and configured to couple the audio driver to the acoustic waveguide; and
a surface disposed opposite the edge and connected between the first face and the second face, the first face oriented to face in a first direction and the audio driver oriented to face in a second direction, wherein the surface is arc-shaped, wherein the surface is tangent to the first face at the point at which the surface is joined with the first face, and perpendicular to the second face at the point at which the surface is joined with the second face; and
wherein when the audio driver is coupled to the second face, a pressure level of sound energy emitted by the audio driver is greater along the second direction than the first direction.

30. The acoustic waveguide according to claim 29, wherein a radius of the arc-shaped surface is a function of a length of the first face and a tangent of the first angle.

31. The acoustic waveguide according to claim 29, wherein a length of the first face is a function of a length of the second face and the first angle.

32. The acoustic waveguide according to claim 29, further comprising a structural component used for installing the acoustic waveguide on a pillar of a vehicle.
